(19) United States
(12) Patent Application Publication
(10) Pub. No.: US 2025/0322531 A1
(43) Pub. Date: Oct. 16, 2025

(54) ANTI-OCCLUSION AUTOMATIC TRACKING SYSTEM FOR FLYING VEHICLE, FLYING VEHICLE WITH ANTI-OCCLUSION AUTOMATIC TRACKING SYSTEM AND ANTI-OCCLUSION AUTOMATIC TRACKING METHOD FOR FLYING VEHICLE

(71) Applicant: INDUSTRIAL TECHNOLOGY RESEARCH INSTITUTE, Hsinchu (TW)

(72) Inventor: Jose Felipe MANOSALVAS BANCHON, Hsinchu (TW)

(73) Assignee: INDUSTRIAL TECHNOLOGY RESEARCH INSTITUTE, Hsinchu (TW)

(21) Appl. No.: 19/173,899

(22) Filed: Apr. 9, 2025

Related U.S. Application Data
(60) Provisional application No. 63/634,348, filed on Apr. 15, 2024.

(30) Foreign Application Priority Data
Jan. 3, 2025 (TW) 114100263

(51) Int. Cl. G06T 7/20; G06T 7/62; G06T 7/70; G06V 10/25

(52) U.S. Cl. CPC G06T 7/20; G06T 7/62; G06T 7/70; G06V 10/25; G06T 2207/20081; G06V 2201/07

(57) ABSTRACT

An anti-occlusion automatic tracking system and method, applicable for a flying vehicle. The system includes a position sensor, an inertial sensor, an image capture device and a computing device. The position sensor is configured to detect real-time position information of the flying vehicle. The inertial sensor is configured to detect real-time inertial information of the flying vehicle. The image capture device is configured to capture real-time image. The computing device is configured to perform target detection on the real-time image to obtain a target area, then obtain a position vector of a target object according to a set of pre-stored size information of the target object and an image size of the target area, and obtain target positioning information of the target object according to the real-time position information, the real-time inertial information and the position vector.

### CROSS-REFERENCE TO RELATED APPLICATIONS

The present application is based on, and claims priority from, U.S. patent application No(s). 63/634,348, filed on Apr. 15, 2024, and Taiwan (International) application No. 114100263, filed on Jan. 3, 2025, the disclosure of which is hereby incorporated by reference herein in its entirety.

### BACKGROUND

### 1. Technical Field

This disclosure relates to an anti-occlusion automatic tracking system and method for flying vehicle.

### 2. Related Art

Nowadays, unmanned aerial vehicle (UAV) equipped with an automated system are increasingly utilized in various high-risk work environments to reduce traditional labor demands. In some scenarios, unmanned aerial vehicle equipped with image capture device may perform target detection based on machine vision and subsequently carry out further interactive operations on the basis of accurate target detection.

### SUMMARY

According to one or more embodiment of this disclosure, an anti-occlusion automatic tracking system, applicable for a flying vehicle, comprises a first position sensor, an inertial sensor, an image capture device and a computing device. The first position sensor is configured to detect real-time position information of the flying vehicle, wherein the real-time position information is based on a global navigation satellite system. The inertial sensor is configured to detect real-time inertial information of the flying vehicle. The image capture device is configured to capture a real-time image. The computing device is in communication with the first position sensor, the inertial sensor and the image capture device, and configured to perform target object detection on the real-time image to obtain a target bounding box, then obtain a position vector of a target relative to the camera based on pre-stored actual size information of the object and the target's bounding box area. The target pose is calculated according to the real-time position and inertial vehicle information, and the previous calculated vector between the camera and the target. Whenever the position, orientation or image is updated, the computing device is further configured to track the target new camera-target vector information based on the updated data.

According to one or more embodiment of this disclosure, a flying vehicle with an anti-occlusion automatic tracking system, comprises a base, a first position sensor, an inertial sensor, an image capture device and a computing device. The first position sensor is disposed at the base, and configured to detect real-time position information of the flying vehicle, wherein the real-time position information is based on position information of a global navigation satellite system. The inertial sensor is disposed at the base, and configured to detect real-time inertial information of the flying vehicle. The image capture device is disposed at the base, and configured to capture a real-time image. The computing device is in communication with the first position sensor, the inertial sensor and the image capture device, configured to perform target object detection on the real-time image to obtain a target bounding box, then obtain a position vector of a target object according to a set of pre-stored size information of the target object and an image size of the target area, and obtain target positioning information of the target object according to the real-time position information, the real-time inertial information and the position vector. When the real-time position information, the real-time inertial information or the real-time image is updated, the computing device is further configured to track the target area in the real-time image according to the target pose, the real-time position information and the real-time inertial information.

According to one or more embodiment of this disclosure, an anti-occlusion automatic tracking method for a flying vehicle, performed by a computing device, comprises: obtaining real-time position information of a flying vehicle through a first position sensor, wherein the real-time position information is based on position information of global navigation satellite system; obtaining real-time inertial information of the flying vehicle through an inertial sensor; obtaining a real-time image through an image capture device; performing target object detection on the real-time image to obtain a target area; obtaining a position vector of a target object according to a set of pre-stored size information of the target object and an image size of the target area; obtaining target positioning information of the target object according to the real-time position information, the real-time inertial information and the position vector; and when the real-time position information, the real-time inertial information or the real-time image is updated, the computing device is further configured to track the target area in the real-time image according to the target pose, the real-time position information and the real-time inertial information.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram illustrating a flying vehicle and an anti-occlusion automatic tracking system of the flying vehicle according to an embodiment of the present disclosure;

FIG. 2 is a flowchart illustrating an anti-occlusion automatic tracking method for a flying vehicle according to an embodiment of the present disclosure;

FIG. 3 is a schematic diagram illustrating performing precise positioning of a flying vehicle according to another embodiment of the present disclosure;

FIGS. 4 and 5 are schematic diagrams illustrating a flying vehicle performing target detection and obtaining a position vector of a target object according to an embodiment of the present disclosure;

FIG. 6 is a schematic diagram illustrating a flying vehicle tracking a target area and locking onto a target object to execute spraying operations according to an embodiment of the present disclosure;

FIG. 7 is a statistical graph illustrating the tracking error of anti-occlusion automatic tracking system and method for a flying vehicle according to an embodiment of the present disclosure; and

FIG. 8 is a functional block diagram illustrating a flying vehicle and an anti-occlusion automatic tracking system of the flying vehicle according to still another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

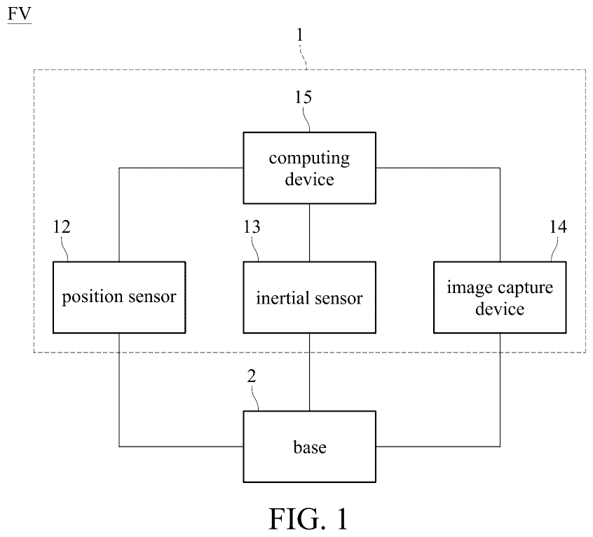

Please refer to FIG. 1, which is a functional block diagram illustrating a flying vehicle and an anti-occlusion automatic tracking system of the flying vehicle according to an embodiment of the present disclosure. As shown in FIG. 1, the flying vehicle FV may include an anti-occlusion automatic tracking system 1 and a base 2. The anti-occlusion automatic tracking system 1 may include a position sensor 12, an inertial sensor 13, an image capture device 14, and a computing device 15. The position sensor 12 may be disposed on the base 2, and configured to detect real-time position information of the flying vehicle FV, wherein the real-time position information is based on global navigation satellite system (GNSS). The inertial sensor 13 may be disposed at the base 2, and configured to detect real-time inertial information of the flying vehicle FV. The image capture device 14 may be disposed at the base 2, and configured to capture a real-time image. The computing device 15 is in communication with the position sensor 12, the inertial sensor 13 and the image capture device 14, and configured to perform target object detection on the real-time image to obtain a target bounding box, then obtain a position vector of a target relative to the camera based on pre-stored actual size information of the object and the target's bounding box area. The target pose is calculated according to the real-time position and inertial vehicle information, and the previous calculated vector between the camera and the target. Whenever the position, orientation or image is updated, the computing device 15 is further configured to track the target new camera-target vector information based on the updated data.

In this embodiment, the flying vehicle FV may be an aircraft, such as a drone with automatic or semi-automatic flight control functionality. The base 2, where the position sensor 12, the inertial sensor 13 and the image capture device 14 are mounted, may include a main body (fuselage) of the flying vehicle FV and/or an extension member (e.g., an extension arm) of the flying vehicle FV. The position sensor 12 may generate real-time position information for the flying vehicle FV based on GNSS. Specifically, the real-time position information may include three-dimensional coordinates of the flying vehicle FV on a global scale. The inertial sensor 13, also known as an inertial measurement unit (IMU), may be configured to measure three-axis attitude angles (angular velocity) and accelerations of the flying vehicle FV, which is information of acceleration, rotation angles, and tilt angles of the flying vehicle FV. For instance, the inertial sensor 13 may be equipped with a three-axis gyroscope and a three-directional accelerometer to measure angular velocity and acceleration of the flying vehicle FV in three-dimensional space, thereby calculating the attitude of the flying vehicle FV. In addition, to improve measurement accuracy, a plurality of inertial sensors 13 may also be installed for each axis of the flying vehicle FV.

The image capture device 14 may be configured to obtain a real-time image along specific axis of the flying vehicle FV. Specifically, the inertial sensor 13 may be configured to measure the attitude angle of the flying vehicle FV at a specific time point, and the attitude angle may be configured to determine the shooting direction of the image capture device 14 at the specific time point. The computing device 15 may be disposed at the base 2 and electrically connected to the position sensor 12, the inertial sensor 13 and the image capture device 14, or the computing device 15 may be remotely disposed and in communication with the position sensor 12, the inertial sensor 13 and the image capture device 14. The computing device 15 may include one or more processing/control units capable of data reception, recording, computation, storage, and output. Examples of the processing/control units include a microcontroller, a central processing unit (CPU), a graphics processing unit (GPU), a programmable logic controller (PLC), or any combination thereof.

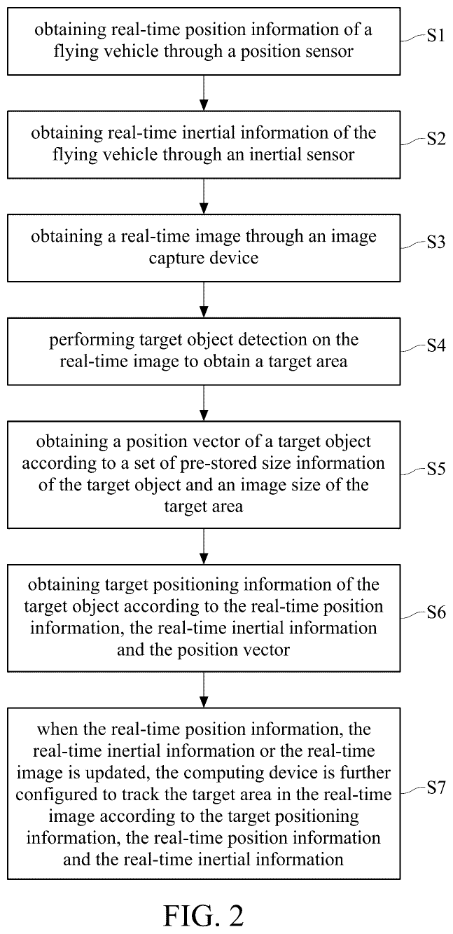

Please refer to FIG. 2 in conjunction with FIG. 1, FIG. 2 is a flowchart illustrating an anti-occlusion automatic tracking method for a flying vehicle according to an embodiment of the present disclosure. As shown in FIG. 2, the anti-occlusion automatic tracking method for a flying vehicle includes execution by the computing device 15 of the following steps: step S1: obtaining real-time position information of a flying vehicle through a position sensor; step S2: obtaining real-time inertial information of the flying vehicle through an inertial sensor; step S3: obtaining a real-time image through an image capture device; step S4: performing target object detection on the real-time image to obtain a target area; step S5: obtaining a position vector of a target object according to a set of pre-stored size information of the target object and an image size of the target area; step S6: obtaining target positioning information of the target object according to the real-time position information, the real-time inertial information and the position vector; and step S7: tracking the target area in the real-time image according to the target pose, the real-time position information and the real-time inertial information when the real-time position information, the real-time inertial information or the real-time image is updated.

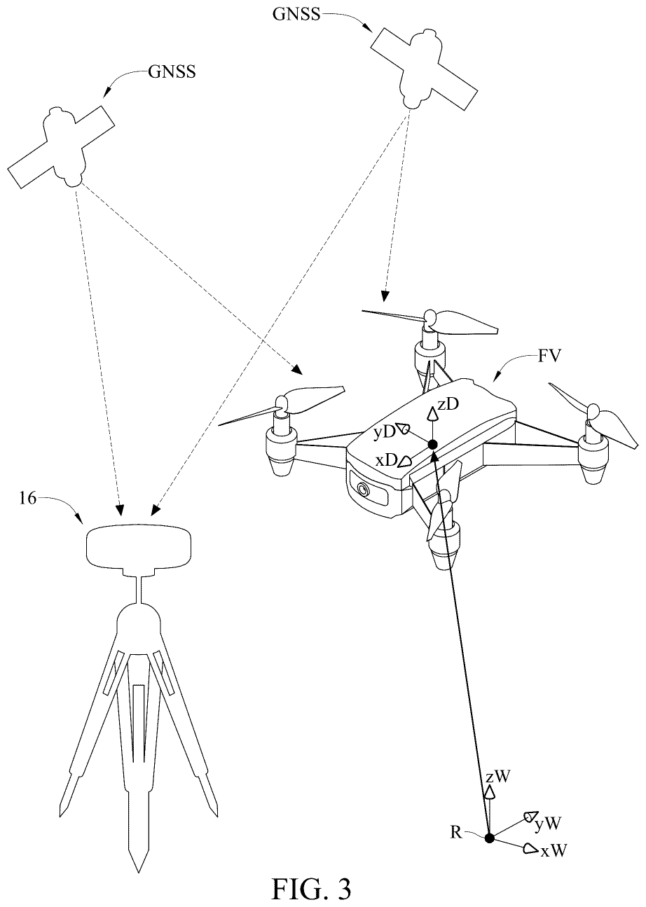

In step S1, the computing device 15 may obtain real-time position information of a drone through the position sensor 12. The real-time position information may be based on the position information of GNSS. Based on accuracy requirement in practice, different types of position sensors or a plurality of position sensors may be utilized for auxiliary positioning. Please refer to FIG. 3, which is a schematic diagram illustrating performing precise positioning of a flying vehicle according to another embodiment of the present disclosure. As shown in FIG. 3, the flying vehicle FV in this example may include each of the devices and components shown in FIG. 1, wherein the position sensor 12 may be regarded as a first position sensor, and may be operated with a second position sensor 16. The first position sensor of the flying vehicle FV and the second position sensor 16 disposed in the environment may employ real-time kinematic (RTK) technology to generate precise real-time position information, thereby enhancing positioning accuracy to a centimeter-level precision. In an embodiment, the second position sensor 16 may be regarded as one of the devices included in the anti-occlusion automatic tracking system. Additionally, the computing device 15 may set the takeoff position R of the flying vehicle FV as (0,0,0) to serve as the origin coordinates for subsequent calculation.

In addition to the aforementioned RTK-based precise positioning, alternative positioning solutions may also be adopted. For example, the Global Positioning System (GPS), Galileo positioning system, and BeiDou Satellite Navigation System based on satellite positioning solutions; a visual odometry, optical flow, an event camera, a ground control point, and simultaneous localization and mapping (SLAM) based on image detection positioning solutions; and LiDAR, radar, and inertial navigation system (INS) based on sensors, all of above may serve as auxiliary positioning techniques to provide precise real-time position information of the flying vehicle FV. The disclosure is not limited to the aforementioned positioning solutions.

In step S2, the computing device 15 may obtain real-time inertial information, including the three-axis attitude angles (angular velocities) and accelerations of the flying vehicle FV, from the inertial sensor 13 disposed at the base 2 of the flying vehicle FV. In step S3, the computing device 15 may obtain a real-time image through the image capture device 14 disposed at the base 2 of the flying vehicle FV. The “real-time information” may represent the real-time measurement information generated by the continuous operation of the sensor and transmitted to the computing device. That is, in steps S1 through S3, the computing device 15 may continuously obtain position information measured by the position sensor 12, inertial information measured by the inertial sensor 13, and the image captured by the image capture device 14. Steps S1 to S3 may be executed in any order or simultaneously.

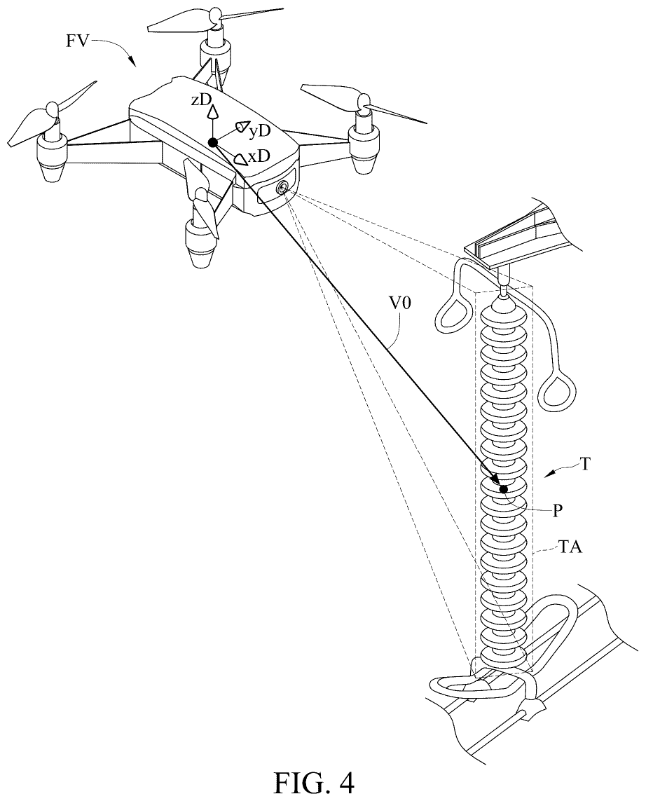

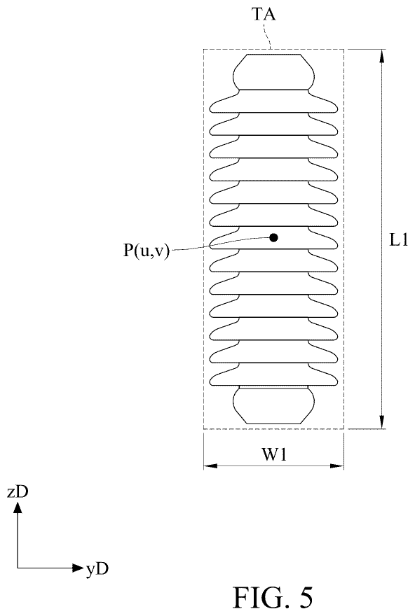

In steps S4 and S5, the computing device 15 may perform target object detection on the real-time image to obtain a target area of a selected (circled) target object, and determine a position vector of the target object based on a set of pre-stored size information for the target object and the image dimensions of the target area. Please refer to FIGS. 4 and 5, which are schematic diagrams illustrating a flying vehicle performing target detection and obtaining a position vector of a target object according to an embodiment of the present disclosure. As shown in FIGS. 4 and 5, when the flying vehicle FV faces the target object T, the image capture device may obtain the real-time image containing the target object image and transmit the real-time image to the computing device. The computing device may select the target object in the real-time image to generate a target area TA, wherein the boundary of the target area TA is a bounding box. For example, the computing device may train a target object recognition model using a plurality of pre-stored images of the target object T, and perform target object detection on the real-time image to obtain the target area according to the target object recognition model. The target object recognition model may be a convolutional neural network used for image segmentation, such as a customized U-Net generative adversarial network (U-Net GAN), but the disclosure is not limited to this.

Then, the computing device may obtain the distance between the flying vehicle FV and the target object T based on the set of pre-stored size information (e.g., length and width) for the target object and the image size (e.g., the number of pixels in the length direction and width direction) of the target area, in order to obtain the position vector V0 of the target object T in the reference coordinate system of the image capture device. For example, when the computing device selects the target area TA, the midpoint P of the target area TA will be locked and the computing device may obtain the length L1 and width W1 of the target area TA in the real-time image. The computing device may further determine the current distance between the flying vehicle FV and the target object T according to the pre-stored length and width of the target object. Specifically, the distance may be determined based on the ratio between the image size and actual size of the target object. For example, the computing device may obtain the distance between the flying vehicle FV and the target object T according to the set of pre-stored size information, the image size and focal length of the image capture device. Please refer to the following Equation (1), wherein d is the distance between the flying vehicle FV and the target object T, f is the focal length of the image capture device, M is the actual size (for example, length or width) of the target object, m is the size in pixels (for example, length L1 or width W1) of the target object in the image.

$$d = \frac{f \times M}{m} \qquad Equation ( 1 )$$

After obtaining the distance between the flying vehicle FV and the target object T through the image, the computing device may calculate the position vector V0 of the target object T relative to the reference coordinate system of the image capture device. Then in step S6, the computing device may obtain target positioning information of the target object T according to the real-time position information, the real-time inertial information and the position vector V0. For example, the real-time position information may correspond to the coordinate position of the flying vehicle FV in space, the real-time inertial information may correspond to the shooting direction of the image capture device, and the position vector V0 may be corresponding to the target object T relative to the vector of the reference coordinate system of the image capture device. Therefore, by adding the above three pieces of geometric information in vector form, the coordinate position of the target object T in space (target positioning information) may be obtained. That is, the computing device may use the coordinate position of the flying vehicle FV as a basis to locate the target object T through shooting an image. This calculation method of the positioning information may be based on the coordinate conversion operation of a vector and a matrix (for example, a rotation matrix), which is not described here.

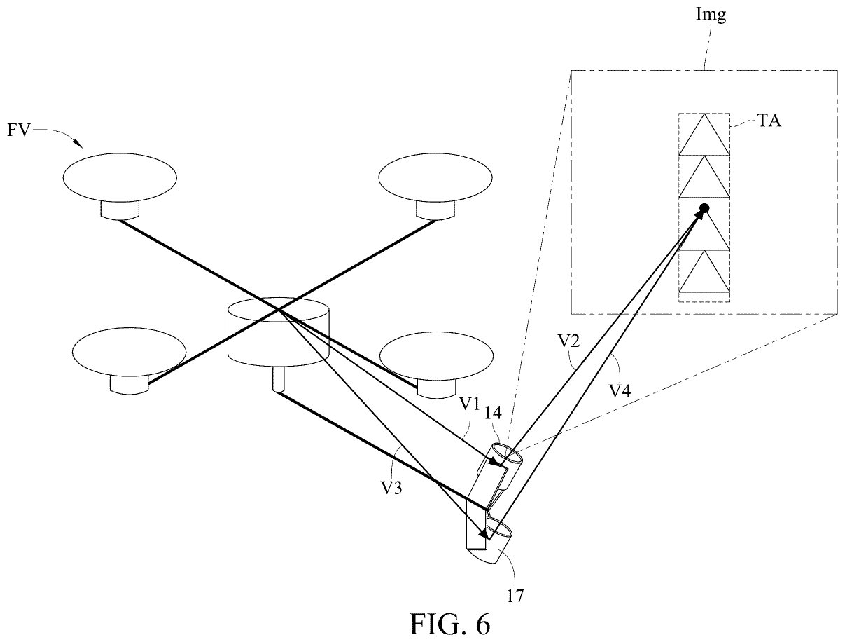

Furthermore, the computing device may store vector information of the installation position of the image capture device relative to the first position sensor, and obtain the target pose of the target object T based on the vector information, the real-time position information, the real-time inertial information and the position vector V0. Please refer to FIG. 6, which is a schematic diagram illustrating a flying vehicle tracking a target area and locking onto a target object to execute spraying operations according to an embodiment of the present disclosure. As shown in FIG. 6, in this example, the first position sensor may be disposed on the main body of the flying vehicle FV, the image capture device 14 may be disposed on the extension member of the flying vehicle FV, the vector V1 may correspond to the relative position between the image capture device 14 and the first position sensor, and vector V2 may correspond to the relative position between the image capture device 14 and the target object. In this way, the computing device may obtain the position of the image capture device based on the position of the flying vehicle FV, and obtain the target pose of the target object by identifying the target area TA in the image Img. At this point, the operation of obtaining the target pose of the target object may be called as a pose back propagation operation, and the absolute position coordinates of the target object relative to the ground may be obtained.

In step S7, when the real-time position information, the real-time inertial information or the real-time image is updated, that is, when the flying vehicle FV is displaced, the attitude is offset, or the image changes due to external reasons, the computing device may track the target area in the real-time image based on the target pose, the real-time position information and the real-time inertial information. For example, when the target object is blocked by a foreign object and the image capture device is unable to obtain a complete image of the target object, causing the target object detection to fail, the computing device may use the previously obtained target positioning information of the target object and position information and inertial information of the flying vehicle FV to continuously track the target area TA in the image. At this point, the operation of continuously tracking the target area TA in the image based on the previously obtained target positioning information of the target object and the position information and inertial information of the flying vehicle FV may be called a pose forward propagation operation, and the relative position coordinates of the target object relative to the flying vehicle FV may be obtained based on the absolute position coordinates of the target object relative to the ground. In this way, the problem of the continuous tracking of the target object being interrupted due to a change occurred in the captured image or the target object being blocked when the flying vehicle of the present disclosure interacts with the target object may be avoided.

In an embodiment, the anti-occlusion automatic tracking system for a flying vehicle may further include an end effector 17, which is disposed on an extension member of the flying vehicle FV and in communication with the computing device. The computing device may be further configured to store vector information of the extension member relative to the first position sensor, and control the end effector 17 to perform a specified operation on the target object based on the vector information, the target pose, the real-time position information and the real-time inertial information. As shown in FIG. 6, in this example, the first position sensor may be disposed on the main body of the flying vehicle FV, the end effector 17 may be disposed on the extension member of the flying vehicle FV, and the vector V3 may correspond to the relative position between the end effector 17 and the first the position sensor, vector V4 may correspond to the relative position between the end effector 17 and the target object. The end effector 17 may be a spray device, a laser device or a robotic arm, etc., to the present disclosure is not limited thereto. In this example, the end effector 17 is a spray device, and the end effector 17 may have at least one rotation shaft, and the computing device may control the end effector 17 to rotate along an operating trajectory of the target area to perform the specified operation to the target object. That is, after obtaining the target pose of the target object, the computing device may calculate the spraying angle required by the spray device based on the vector information, the target pose, the real-time position information and the real-time inertial information, to perform spraying operation on the target object. The calculation method of the rotation angle of the end effector 17 may refer to the inverse kinematics of the robot manipulator, which is not further described here.

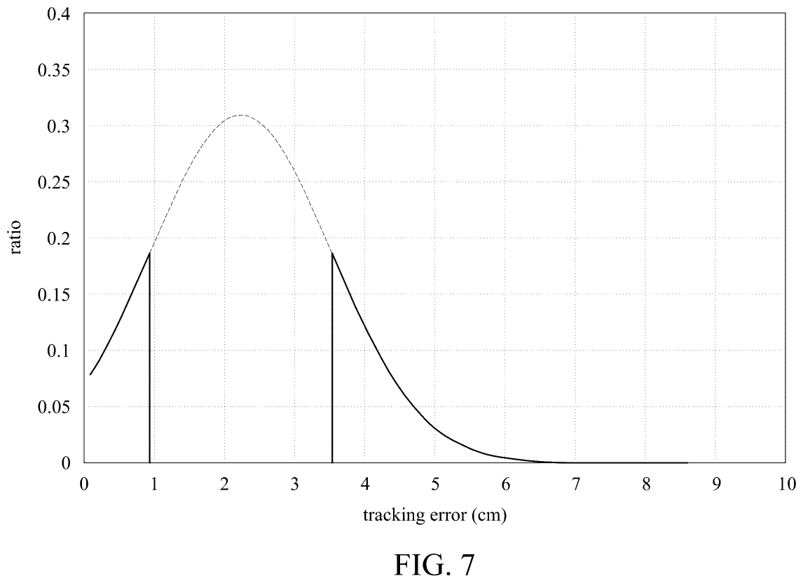

Furthermore, after obtaining the target pose of the target object in step S6, even if the position or attitude of the flying vehicle FV deviates or the target object in the image is occluded, the computing device may still continue to track the target area TA in the image (step S7), whereby the computing device may further control the spray device (end effector 17) to continuously track the target area TA and perform the spraying operation. Please refer to FIG. 7, which is a statistical graph illustrating the tracking error of anti-occlusion automatic tracking system and method for a flying vehicle according to an embodiment of the present disclosure. As shown in FIG. 7, according to the aforementioned embodiments of the anti-occlusion automatic tracking system and method for the flying vehicle of the present disclosure, it has been experimentally verified that the error range between the aiming point of the end effector in the target area and the actual center point of the target object belongs to the range of centimeter grade, and most of which fall within the range of about 2 centimeters. Please refer to the following Table (A) for detailed experimental data.

TABLE (A):

| | Error of X(cm) | Error of Y(cm) | Distance(cm) |
|---|---|---|---|
| Mean | 0.47 | −0.27 | 2.227 |
| Maximum | 7.79 | 6.71 | 8.572 |
| Standard deviation | 1.27 | 2.17 | 1.289 |

According to FIG. 7 and Table (A), it may be seen that the anti-occlusion automatic tracking system and method for a flying vehicle of the present disclosure may make the tracking and aiming offset error of the flying vehicle due to translational or rotational movement reach an average of 2.27 centimeters.

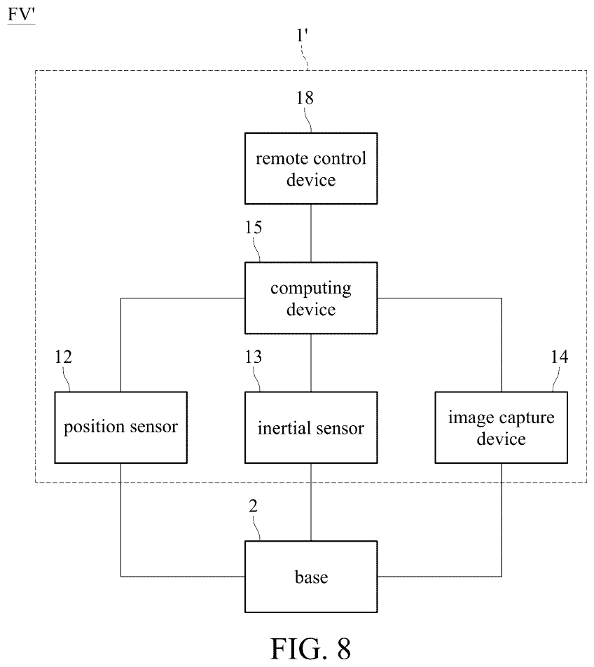

Please refer to FIG. 8, which is a functional block diagram illustrating a flying vehicle and an anti-occlusion automatic tracking system of the flying vehicle according to still another embodiment of the present disclosure. Compared with the embodiment of FIG. 1, the anti-occlusion automatic tracking system 1′ included in the flying vehicle FV′ of this example may further include a remote control device 18. The remote control device 18 is in communication with the computing device 15, and the remote control device 18 may control the computing device 15 to re-perform the target object detection when determining that the target area has an error. For example, the remote control device 18 may determine whether an error occurs in tracking based on the center point of the target area, and re-perform the target object detection when an error occurs in tracking. The above-mentioned operations and determinations of the remote control device 18 may be implemented based on human operation or automatic control. Specifically, the remote control device 18 may include one or more processing/control unit with the function of data reception, recording, calculation, storage and output, and the processing/control unit is, for example, a microcontroller, a central processing unit, a graphics processing unit, a programmable logic controller, or any combination of the above.

In view of the above description, the anti-occlusion automatic tracking system for a flying vehicle, the flying vehicle with an anti-occlusion automatic tracking system and the anti-occlusion automatic tracking method for a flying vehicle of the present disclosure, may obtain target positioning information according to position vector between a flying vehicle and a target object, real-time inertial information, real-time position information of the flying vehicle in the first stage; and in the second stage, may track a target area of a real-time image according to the target pose, the real-time position information and the real-time inertial information. In this way, the problem of the continuous tracking of the target object being interrupted due to a change occurred in the captured image or the target object being blocked when the flying vehicle of the present disclosure interacts with the target object may be avoided, and an anti-occlusion automatic tracking system and method applicable for a flying vehicle may be realized. In addition, through the positioning method of real-time dynamic positioning technology, the anti-occlusion automatic tracking system for a flying vehicle, the flying vehicle with an anti-occlusion automatic tracking system and the anti-occlusion automatic tracking method for a flying vehicle of the present disclosure may still track the target position.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. An anti-occlusion automatic tracking system, applicable for a flying vehicle, comprising:
a first position sensor configured to detect real-time position information of the flying vehicle, wherein the real-time position information is based on a global navigation satellite system;
an inertial sensor configured to detect real-time inertial information of the flying vehicle;
an image capture device configured to capture a real-time image; and
a computing device in communication with the first position sensor, the inertial sensor and the image capture device, and configured to perform target object detection on the real-time image to obtain a target area, then obtain a position vector of a target object according to a set of pre-stored size information of the target object and an image size of the target area, and obtain target positioning information of the target object according to the real-time position information, the real-time inertial information and the position vector,
wherein the computing device is further configured to track the target area in the real-time image according to the target pose, the real-time position information and the real-time inertial information when the real-time position information, the real-time inertial information or the real-time image is updated.

2. The anti-occlusion automatic tracking system according to claim 1, further comprising a second position sensor, wherein the real-time position information is obtained by the first position sensor and the second position sensor based on real-time dynamic positioning technology.

3. The anti-occlusion automatic tracking system according to claim 1, wherein the real-time inertial information comprises information of acceleration, rotation angle and tilt angle of the flying vehicle.

4. The anti-occlusion automatic tracking system according to claim 1, wherein the computing device is configured to obtain the position vector of the target object according to the set of pre-stored size information, the image size, focal length of the image capture device and a reference coordinate system of the image capture device.

5. The anti-occlusion automatic tracking system according to claim 1, wherein the computing device is configured to store vector information of installation position of the image capture device relative to the first position sensor, and obtain the target pose of the target object according to the vector information, the real-time position information, the real-time inertial information and the position vector.

6. The anti-occlusion automatic tracking system according to claim 1, further comprising an end effector in communication with the computing device,
wherein the computing device is further configured to store vector information of an extension member of the flying vehicle relative to the first position sensor, and control the end effector to perform a specified operation on the target object according to the vector information, the target pose, the real-time position information and the real-time inertial information.

7. The anti-occlusion automatic tracking system according to claim 6, wherein the end effector has at least one rotation shaft, and the computing device is configured to control the end effector to rotate along an operation track of the target area to perform the specified operation on the target object.

8. The anti-occlusion automatic tracking system according to claim 1, further comprising a remote control device in communication with the computing device,
wherein the remote control device controls the computing device to re-perform the target object detection when the remote control device determines that the target area has a deviation.

9. The anti-occlusion automatic tracking system according to claim 1, wherein the computing device is configured to train a target object recognition model using a plurality of pre-stored images of the target object, and perform target object detection on the real-time image according to the target object recognition model to obtain the target area.

10. A flying vehicle with an anti-occlusion automatic tracking system, comprising:
a base;
a first position sensor disposed at the base, configured to detect real-time position information of the flying vehicle, wherein the real-time position information is based on position information of global navigation satellite system;
an inertial sensor disposed at the base, configured to detect real-time inertial information of the flying vehicle;
an image capture device disposed at the base, configured to capture a real-time image; and
a computing device in communication with the first position sensor, the inertial sensor and the image capture device, configured to perform target object detection on the real-time image to obtain a target area, then obtain a position vector of a target object according to a set of pre-stored size information of the target object and an image size of the target area, and obtain target positioning information of the target object according to the real-time position information, the real-time inertial information and the position vector,
wherein the computing device is further configured to track the target area in the real-time image according to the target pose, the real-time position information and the real-time inertial information when the real-time position information, the real-time inertial information or the real-time image is updated.

11. The flying vehicle according to claim 10, further comprising a second position sensor, wherein the real-time position information is obtained by the first position sensor and the second position sensor based on real-time dynamic positioning technology.

12. The flying vehicle according to claim 10, wherein the real-time inertial information comprises information of acceleration, rotation angle and tilt angle of the flying vehicle.

13. The flying vehicle according to claim 10, wherein the computing device is configured to obtain the position vector of the target object according to the set of pre-stored size information, the image size and focal length of the image capture device.

14. The flying vehicle according to claim 10, wherein the computing device is configured to store vector information of installation position of the image capture device relative to the first position sensor, and obtain the target pose of the target object according to the vector information, the real-time position information, the real-time inertial information and the position vector.

15. The flying vehicle according to claim 10, further comprising an extension member an end effector, and the end effector disposed at the extension member and in communication with the computing device,
wherein the computing device is further configured to store vector information of the extension member of the flying vehicle relative to the first position sensor, and control the end effector to perform a specified operation on the target object according to the vector information, the target pose, the real-time position information and the real-time inertial information.

16. The flying vehicle according to claim 15, wherein the end effector has at least one rotation shaft, and the computing device is configured to control the end effector to rotate along an operation track of the target area to perform the specified operation on the target object.

17. The flying vehicle according to claim 10, further comprising a remote control device, in communication with the computing device,
wherein when the remote control device determines that the target area has a deviation, controlling the computing device to re-perform the target object detection.

18. The flying vehicle according to claim 10, wherein the computing device is configured to train a target object recognition model with a plurality of pre-stored images of the target object, and perform target object detection on the real-time image according to the target object recognition model to obtain the target area.

19. An anti-occlusion automatic tracking method for a flying vehicle, performed by a computing device, comprising:
obtaining real-time position information of a flying vehicle through a first position sensor, wherein the real-time position information is based on position information of global navigation satellite system;
obtaining real-time inertial information of the flying vehicle through an inertial sensor;
obtaining a real-time image through an image capture device;
performing target object detection on the real-time image to obtain a target area;
obtaining a position vector of a target object according to a set of pre-stored size information of the target object and an image size of the target area;
obtaining target positioning information of the target object according to the real-time position information, the real-time inertial information and the position vector; and
tracking the target area in the real-time image according to the target pose, the real-time position information and the real-time inertial information when the real-time position information, the real-time inertial information or the real-time image is updated.

20. The anti-occlusion automatic tracking method according to claim 19, wherein obtaining the real-time position information of the flying vehicle comprises:
obtaining the real-time position information based on real-time dynamic positioning technology through the first position sensor and a second position sensor.

21. The anti-occlusion automatic tracking method according to claim 19, wherein the real-time inertial information comprises information of acceleration, rotation angle and tilt angle of the flying vehicle.

22. The anti-occlusion automatic tracking method according to claim 19, wherein obtaining the position vector of the target object comprises:
obtaining the position vector of the target object according to the set of pre-stored size information, the image size, focal length of the image capture device and reference coordinate system of the image capture device.

23. The anti-occlusion automatic tracking method according to claim 19, wherein obtaining The target pose of the target object comprises:
obtaining vector information of installation position of the image capture device relative to the first position sensor; and
obtaining the target pose of the target object according to the vector information, the real-time position information, the real-time inertial information and the position vector.

24. The anti-occlusion automatic tracking method according to claim 19, further comprising:
obtaining vector information of an extension member of the flying vehicle, wherein an end effector is disposed on the extension member; and
controlling the end effector to perform a specified operation on the target object according to the vector information, the target pose, the real-time position information and the real-time inertial information.

25. The anti-occlusion automatic tracking method according to claim 24, wherein the end effector has at least one rotation shaft, and controlling the end effector to perform the specified operation on the target object comprises:
controlling the end effector to rotate along an operation track of the target area to perform the specified operation on the target object.

26. The anti-occlusion automatic tracking method according to claim 19, further comprising execution by a remote control device of:
controlling the computing device to re-perform the target object detection when determining that the target area has a deviation.

27. The anti-occlusion automatic tracking method according to claim 19, wherein performing target object detection on the real-time image to obtain the target area comprises:
training a target object recognition model with a plurality of pre-stored images of the target object, and performing target object detection on the real-time image according to the target object recognition model to obtain the target area.
